(19) United States
(12) Patent Application Publication
(10) Pub. No.: US 2022/0327920 A1
(43) Pub. Date: Oct. 13, 2022

(54) DATA COLLECTION FROM FLEET OF VEHICLES

(71) Applicant: Ford Global Technologies, LLC, Dearborn, MI (US)

(72) Inventors: Christopher Leon Jones, Detroit, MI (US); Jacob Martin Povirk, Franklin, MI (US); Austin Kirchner, Denver, CO (US); Charles Robert Maxwell Zine, Detriot, MI (US); David Alfred Ostrowski, Northville, MI (US)

(73) Assignee: Ford Global Technologies, LLC, Dearborn, MI (US)

(21) Appl. No.: 17/225,224

(22) Filed: Apr. 8, 2021

(51) Int. Cl. G08G 1/01; H04W 4/46

(52) U.S. Cl. CPC G08G 1/0133; G08G 1/0112; G08G 1/0145; H04W 4/46

(57) ABSTRACT

A computer includes a processor and a memory storing instructions executable by the processor to determine a predicted classification related to a road segment; upon a vehicle including the computer traveling over the road segment, determine an actual classification related to the road segment; in response to the actual classification failing to match the predicted classification, transmit a notification to a server remote from the vehicle; and upon receiving an instruction responsive to the notification, transmit vehicle data related to the road segment to the server.

### BACKGROUND

Modern vehicles often include a plurality of sensors that generate data. The sensors can provide data about the operation of the vehicle, for example, wheel speed, wheel orientation, steering angle, steering-wheel angle, steering-column torque, gear shifting, accelerator-pedal position, brake-pedal position, brake-pad application force, and engine and transmission data (e.g., temperature, fuel consumption, etc.). For example, the sensors can include torque sensors, position sensors, temperature sensors, etc. The sensors can detect the location and/or orientation of the vehicle. For example, the sensors can include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors can detect the external world, e.g., objects and/or characteristics of surroundings of the vehicle, such as other vehicles, road lane markings, traffic lights and/or signs, pedestrians, etc. For example, the sensors can include radar sensors, scanning laser range finders, light detection and ranging (LIDAR) devices, and image processing sensors such as cameras.

### BRIEF DESCRIPTION OF THE DRAWINGS

FIG. 1 is a diagram of an example communication infrastructure for a fleet of vehicles.

FIG. 2 is a block diagram of an example vehicle of the fleet.

FIG. 3 is a diagram of the vehicle following an example vehicle path along an example road.

FIG. 4 is a process flow diagram of an example process for transmitting vehicle data from the vehicle to a server.

FIG. 5 is a process flow diagram of an example process for instructing the vehicles to transmit the vehicle data to the server.

### DETAILED DESCRIPTION

The system described herein provides a resource-efficient way to capture vehicle data from anomalous situations. Vehicles include map data with classifications of road segments and a model for predicting vehicle behavior over the road segments. The vehicles notify a server remote from the vehicles when the road segments have different classifications than the map data, e.g., when road construction has changed a number of lanes of a road segment, and when the model incorrectly predicts the behavior of the vehicle, e.g., when a vehicle path has a higher curvature than a predicted vehicle path along the road segment. The server can then instruct the vehicles from which it has received notifications to transmit time-series data of the road segment. If the time-series data from the vehicles would be too large for the server, the server can instead instruct a subset of the vehicles to transmit the time-series data, e.g., if the notifications all relate to the same road segment. In other words, vehicles only offer to transmit data in certain circumstances, and the server can limit data gathering to only some of those vehicles. The server can thus limit data-gathering to relatively unusual circumstances—when the predictions for the road segment or the vehicle behavior were inaccurate—thereby conserving resources such as available memory and network bandwidth while still capturing the most interesting data.

A computer includes a processor and a memory storing instructions executable by the processor to determine a predicted classification related to a road segment; upon a vehicle including the computer traveling over the road segment, determine an actual classification related to the road segment; in response to the actual classification failing to match the predicted classification, transmit a notification to a server remote from the vehicle; and upon receiving an instruction responsive to the notification, transmit vehicle data related to the road segment to the server.

The instructions may further include instructions to, upon failing to receive the instruction responsive to the notification, refrain from transmitting the vehicle data.

The predicted classification related to the road segment may be a predicted classification of the road segment, and the actual classification related to the road segment may be an actual classification of the road segment. The predicted classification of the road segment may be a predicted physical layout of the road segment, and the actual classification of the road segment may be an actual physical layout of the road segment. The memory may be storing map data including the predicted physical layout of the road segment.

The predicted classification related to the road segment may be a predicted operation of the vehicle while traveling over the road segment, and the actual classification related to the road segment may be an actual operation of the vehicle while traveling over the road segment. The predicted operation of the vehicle may include predicted operation data for at least one of propulsion, steering, and braking, and the actual operation of the vehicle may include operation data for at least one of propulsion, steering, and braking.

The predicted operation of the vehicle may include a predicted vehicle path along the road segment, and the actual operation of the vehicle may include an actual vehicle path along the road segment.

Determining the predicted operation of the vehicle while traveling over the road segment may be based on a predicted classification of the road segment.

The vehicle data may be time-series data.

The vehicle data may include operation data for at least one of propulsion, steering, and braking.

A server includes a processor and a memory storing instructions executable by the processor to receive a plurality of notifications from a plurality of vehicles, the notifications indicating that respective actual classifications related to respective road segments traveled over by the respective vehicles fail to match respective predicted classifications related to the respective road segments; determine whether vehicle data related to the notifications exceeds a capacity of the server; upon determining that the vehicle data is within the capacity, transmit instructions to transmit the vehicle data to the vehicles; upon determining that the vehicle data exceeds the capacity, select a subset of the vehicles; and then transmit instructions to transmit the vehicle data to the vehicles in the subset.

Selecting the subset of the vehicles may include selecting a random sample from among the vehicles. The random sample may be from the vehicles for which the notifications are of the same road segment.

The instructions may include instructions to transmit map data to the vehicles, and the map data may include predicted classifications of the road segments. At least one of the predicted classifications of the road segments may be based on the vehicle data about the respective road segments.

The instructions may include instructions to set the predicted classifications to unclassified for the road segments for which at least a time threshold has elapsed since receiving the vehicle data.

The capacity of the server may be a quantity of the memory available to store the vehicle data.

The instructions may include instructions to transform the vehicle data into aggregated data, and then delete the vehicle data.

A method includes determining a predicted classification related to a road segment; upon a vehicle traveling over the road segment, determining an actual classification related to the road segment; in response to the actual classification failing to match the predicted classification, transmitting a notification to a server remote from the vehicle; and upon receiving an instruction responsive to the notification, transmitting vehicle data related to the road segment to the server.

With reference to the Figures, a computer 100 of a vehicle 102 includes a processor and a memory storing instructions executable by the processor to determine a predicted classification related to a road segment 104; upon the vehicle 102 traveling over the road segment 104, determine an actual classification related to the road segment 104; in response to the actual classification failing to match the predicted classification, transmit a notification to a server 106 remote from the vehicle 102; and upon receiving an instruction responsive to the notification, transmit vehicle data related to the road segment 104 to the server 106.

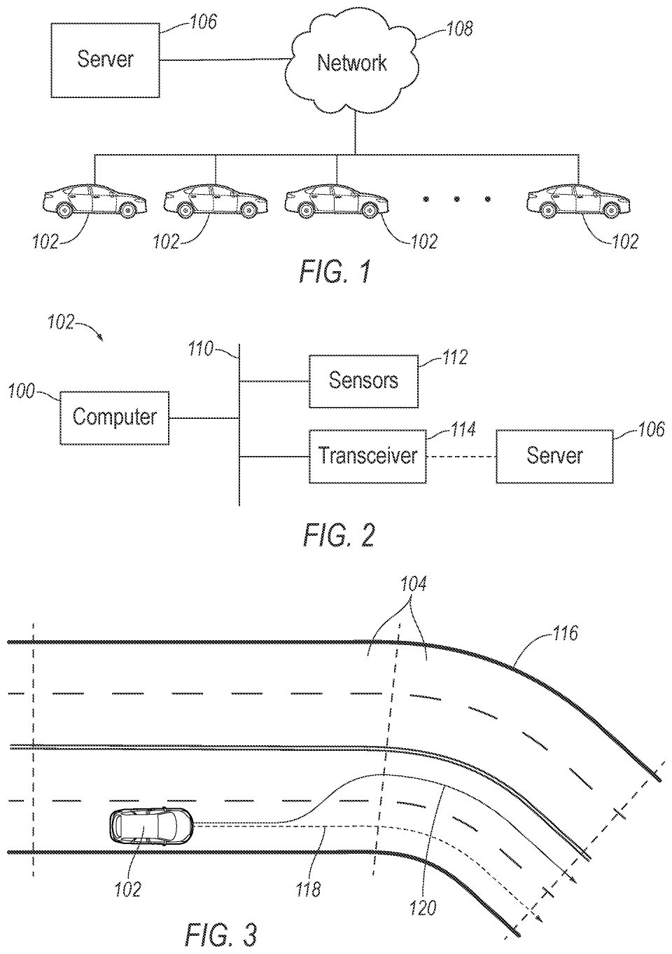

With reference to FIG. 1, a plurality of vehicles 102 are in communication with the server 106 at a given time. For example, the plurality of vehicles 102 can be vehicles from a common manufacturer and/or signed up for a common online service. For another example, the plurality of vehicles 102 can have a common owner, e.g., a fleet of ride-hailing vehicles.

The server 106 is a microprocessor-based computing device, e.g., a generic computing device including a processor and a memory. The memory of the server 106 can include media for storing instructions executable by the processor as well as for electronically storing data and/or databases. The server 106 can be multiple processors and/or memories coupled together. For example, the server 106 can be a data lake, i.e., a repository of data in a natural or raw format, i.e., stored in a flat architecture rather than a hierarchical architecture.

The vehicles 102 and the server 106 communicate through a network 108. The network 108 represents one or more mechanisms by which the vehicles 102 and the server 106 may communicate with each other. Accordingly, the network 108 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

With reference to FIG. 2, each vehicle 102 may be any passenger or commercial automobile such as a car, a truck, a sport utility vehicle, a crossover, a van, a minivan, a taxi, a bus, etc.

The vehicle 102 includes the computer 100. The computer 100 is a microprocessor-based computing device, e.g., a generic computing device including a processor and a memory, an electronic controller or the like, a field-programmable gate array (FPGA), an application-specific integrated circuit (ASIC), etc. The computer 100 can thus include a processor, a memory, etc. The memory of the computer 100 can include media for storing instructions executable by the processor as well as for electronically storing data and/or databases, and/or the computer 100 can include structures such as the foregoing by which programming is provided. The computer 100 can be multiple computers on board the vehicle 102 coupled together. For one example, the computer 100 can be a graphical processing unit (GPU), i.e., a specialized circuit arranged for highly parallel processing, e.g., such as used for creating images in a frame buffer for outputting to a display device.

The computer 100 may transmit and receive data within the vehicle 102 through a communications network 110 such as a controller area network (CAN) bus, Ethernet, WiFi, Local Interconnect Network (LIN), onboard diagnostics connector (OBD-II), and/or by any other wired or wireless communications network. The computer 100 may be communicatively coupled to a plurality of sensors 112, a transceiver 114, and other components via the communications network 110.

The sensors 112 may provide data about operation of the vehicle 102, for example, wheel speed, wheel orientation, steering angle, steering-wheel angle, steering-column torque, gear shifting, accelerator-pedal position, brake-pedal position, brake-pad application force, and engine and transmission data (e.g., temperature, fuel consumption, etc.). For example, the sensors 112 may include torque sensors, position sensors, temperature sensors, etc. The sensors 112 may detect the location and/or orientation of the vehicle 102. For example, the sensors 112 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 112 may detect the external world, e.g., objects and/or characteristics of surroundings of the vehicle 102, such as other vehicles, road lane markings, traffic lights and/or signs, pedestrians, etc. For example, the sensors 112 may include radar sensors, scanning laser range finders, light detection and ranging (LIDAR) devices, and image processing sensors such as cameras.

The transceiver 114 is adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 114 may be one device or may include a separate transmitter and receiver.

With reference to FIG. 3, the vehicle 102 travels along a road 116. The road 116 is divided into road segments 104 according to map data stored in the memory of the computer 100. For the purpose of this disclosure, a “road segment” is an area of the road 116. A road segment 104 typically extends along the direction of travel of the vehicle 102 from a start point to an end point; i.e., the road 116 is divided into the road segments 104 at points or lines arranged lengthwise along the road 116.

The road segments 104 can be classified into types. A type or classification of a road segment 104 specifies one or more characteristics or features of the road segment 104 in which it is like other road segments sharing the characteristic(s) or feature(s), and unlike road segments 104 that cannot share the characteristic)s) or feature(s). For example, a road segment 104 could be of a straight type, and a road segment 104 of a curved type could not be included in the straight classification. The classifications of the road segments 104 include physical layouts of the road segments 104. For example, the classification can depend on numbers of lanes in each direction, division of lanes in opposite directions (e.g., median or lane divider), passing into an oncoming lane permitted or prohibited, presence or absence of shoulders, presence or absence of dedicated turning lanes, curvature along the road segment 104, gravel or pavement, etc. Other characteristics of the road segment 104 can contribute to the classification, e.g., speed limit, traffic-control signs or signals, etc.

The memory of the computer 100 on board the vehicle 102 can store map data provided by the server 106 that includes the predicted classifications of the road segments 104. For example, the map data can conform to Advanced Driver Assistance Systems Interface Specifications (ADASIS) standards, published by ADASIS of Brussels, Belgium, https://adasis.org. The memory of the computer 100 on board the vehicle 102 can also store a machine-learning program for determining the actual classifications of the road segments 104 that the vehicle 102 travels over, as described below with respect to a block 425 of a process 400. As described below with respect to a process 500, the server 106 can change the predicted classifications of the road segments 104 in the map data based on receiving notifications from the vehicles 102 of different actual classifications of the road segments 104, and then transmit the updated map data to the vehicles 102.

The operation of the vehicle 102 along the road segment 104 can be described by several characteristics, e.g., position, speed, acceleration or deceleration, heading, yaw rate, etc. These characteristics may be known directly from data from one of the sensors 112, e.g., speed, and/or can be calculated from data from the sensors 112, e.g., acceleration from accelerator-pedal position, brake force, etc. These characteristics can change over time along the road segment 104. For example, the position of the vehicle 102 over time forms a vehicle path. The memory of the computer 100 on board the vehicle 102 can store a model for predicting the operation of the vehicle 102 along the road segments 104, described below with respect to a block 415 of the process 400. For example, FIG. 3 shows a predicted vehicle path 118 generated by the model and an actual vehicle path 120 traveled by the vehicle 102, which in this example deviates from the predicted vehicle path 118.

A vehicle path 118 can be specified according to one or more path polynomials. A path polynomial is a polynomial function of degree three or less that describes the motion of a vehicle on a ground surface. Motion of a vehicle on a roadway is described by a multi-dimensional state vector that includes vehicle location, orientation, speed, and acceleration. Specifically, the vehicle motion vector can include positions in x, y, z, yaw, pitch, roll, yaw rate, pitch rate, roll rate, heading velocity and heading acceleration that can be determined by fitting a polynomial function to successive 2D locations included in the vehicle motion vector with respect to the ground surface, for example.

Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

p(x)=a₀+a₁x+a₂x²+a₃x³ (1)

where a₀ an offset, i.e., a lateral distance between the path and a center line of the host vehicle 105 at the upcoming distance x, a₁ is a heading angle of the path, a₂ is the curvature of the path, and a₃ is the curvature rate of the path. Accordingly, a model can predict a vehicle path 118 based on data forming a vehicle motion vector, as described above.

The sensors 112 generate vehicle data describing the operation of the vehicle 102 along the actual vehicle path 120. The vehicle data is time-series data. As will be generally understood, and for purposes of this disclosure, time-series data are values of one or more variables at discrete successive points of time. The vehicle data can include operation data for propulsion, e.g., accelerator-pedal position, drivetrain torque, wheel speed, vehicle speed, etc.; steering, e.g., steering-wheel angle, steering angle, steering-column torque, etc.; and/or braking, e.g., brake-pedal position, braking force, etc.

The server 106 stores aggregated data that is generated from the vehicle data transmitted from the plurality of vehicles 102. The aggregated data is data in a form that condenses or summarizes the vehicle data from which it is generated. For example, the aggregated data can be time-series data for each of the road segments 104 representing a confidence interval, e.g., 95%, of the vehicle data that has been received; e.g., the aggregated data can include a time series of upper and lower bounds encompassing a 95% confidence interval of, e.g., accelerator-pedal positions for each time step along that road segment 104.

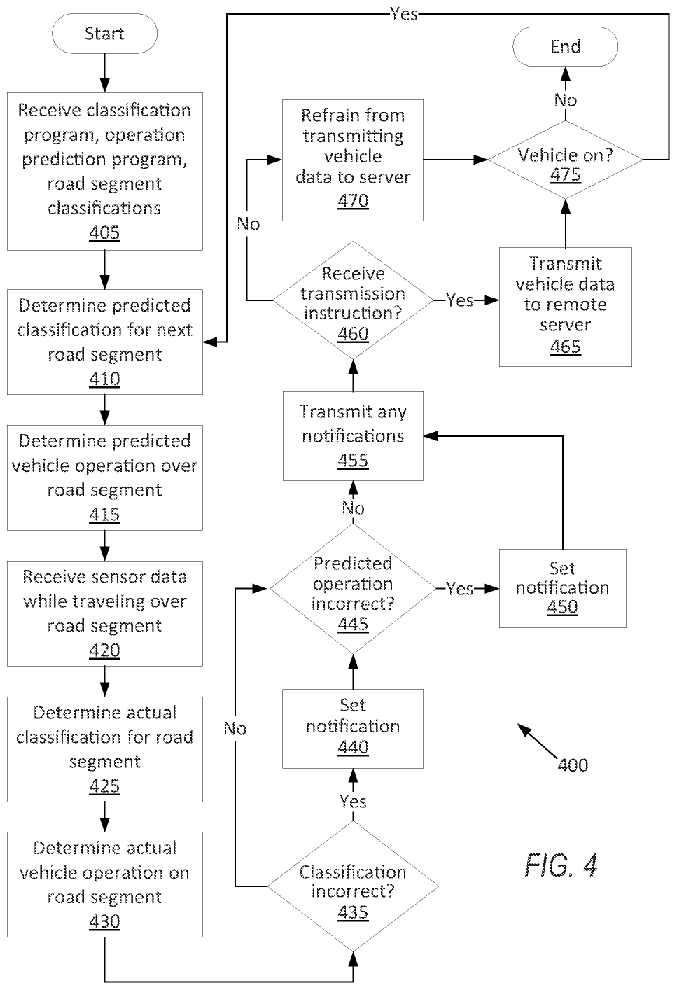

FIG. 4 is a process flow diagram illustrating an exemplary process 400 for transmitting the vehicle data from one of the vehicles 102 to the server 106. The memories of the computers 100 of each of the plurality of vehicles 102 store executable instructions for performing the steps of the process 400 and/or programming can be implemented in structures such as mentioned above. As a general overview of the process 400, the computer 100 of the vehicle 102 receives the machine-learning program for classifying the road segments 104, the model for predicting the operation of the vehicle 102, and the map data including the classifications of the road segments 104. The computer 100 determines predicted classifications related to the road segment 104, specifically the predicted classification of the road segment 104 and the predicted operation of the vehicle 102 while traveling over the road segment 104. The computer 100 receives data from the sensors 112 while traveling over the road segment 104 and determines the actual classifications related to the road segment 104, specifically the actual classification of the road segment 104 and the actual operation of the vehicle 102 while traveling over the road segment 104. For each predicted classification related to the road segment 104 that fails to match the actual classification, the computer 100 sets a notification, and the computer 100 transmits any notifications to the server 106. If the computer 100 receives a transmission instruction from the server 106, the computer 100 transmits the vehicle data gathered while traveling over the road segment 104 to the server 106, and if not, the computer 100 refrains from transmitting the vehicle data. The computer 100 iterates these steps for as long as the vehicle 102 remains on.

The process 400 begins in a block 405, in which the computer 100 receives the machine-learning program for classifying the road segments 104, the model for predicting the operation of the vehicle 102 (which are both described in further detail below), and the map data including the classifications of the road segments 104.

Next, in a block 410, the computer 100 determines the predicted classification of the next road segment 104 that the vehicle 102 will travel over. For example, the computer 100 can look up the predicted classification of the next road segment 104 from the map data stored in memory.

Next, in a block 415, the computer 100 determines the predicted operation of the vehicle 102 while traveling over the next road segment 104. The computer 100 runs the model for predicting the operation of the vehicle 102 to determine the predicted operation. As explained below, the model can be a statistical model and/or a machine learning program. The input for the model can be the predicted classification of the next road segment 104, and the model can output the predicted operation based on the predicted classification of the next road segment 104. The predicted operation outputted by the model includes predicted operation data for at least one of propulsion, steering, and braking—e.g., for propulsion, accelerator-pedal position, drivetrain torque, wheel speed, vehicle speed, etc.; for steering, steering-wheel angle, steering angle, steering-column torque, etc.; and/or for braking, brake-pedal position, braking force, etc. The predicted operation can also include a predicted vehicle path 118 along the next road segment 104. For example, the model can output statistical means or medians of those operation data from a large sample of vehicles 102 of a same type as the vehicle 102 traveling over road segments 104 of the same classification as the next road segment 104. The predicted vehicle path 118 can be constructed from the predicted operation data, e.g., determining values for a vehicle motion vector over time to generate a path polynomial or polynomials as described above and using known curve-generating techniques, e.g., polyline, Euler spiral, basis spline, radius of curvature differential equations, vehicle dynamics model, etc. For another example, the model can be generated by a machine learning, e.g., unsupervised machine learning that generates clusters based on, e.g., experimental data of actual operations of the vehicle 102 over different road segments 104. Different measures of similarity can be used for the machine learning, e.g., Kullback-Leibler divergence, cosine similarity, Euclidean distance, Mahalanobis distance, etc. The predicted operation for each cluster can be represented by the cluster's centroid or by a prototype, i.e., a data point (in this case one of the actual operations) that represents a respective cluster. The model then outputs the predicted operation of the cluster in which the predicted classification of the next road segment 104 is most represented.

Next, in a block 420, the computer 100 receives data from the sensors 112 while the vehicle 102 travels over the next road segment 104, now the current road segment 104.

Next, in a block 425, the computer 100 determines the actual classification of the current road segment 104 based on the sensor data. For example, the computer 100 can classify the current road segment 104 using image data from cameras of the sensors 112 and applying conventional image-recognition techniques, e.g., a convolutional neural network programmed to accept images as input and output a classification of the current road segment 104. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential classification for the current road segment 104, and the final output, i.e., the actual classification, is the classification with the highest score.

Next, in a block 430, the computer 100 determines the actual operation of the vehicle 102 while traveling over the current road segment 104. The actual operation is given by the operation data, which is a subset of the data received from the sensors 112 in the block 420. The actual operation includes operation data for at least one of propulsion, steering, and braking—e.g., for propulsion, accelerator-pedal position, drivetrain torque, wheel speed, vehicle speed, etc.; for steering, steering-wheel angle, steering angle, steering-column torque, etc.; and/or for braking, brake-pedal position, braking force, etc. The actual operation can also include the actual vehicle path 120 along the current road segment 104. The actual vehicle path 120 can be constructed from the operation data using known curve-generating techniques, e.g., polyline, Euler spiral, basis spline, radius of curvature differential equations, vehicle dynamics model, etc.

Next, in a decision block 435, the computer 100 determines whether the actual classification of the current road segment 104 from the block 425 matches the predicted classification of the current road segment 104 from the block 415. The actual classification of the current road segment 104 matches the predicted classification of the current road segment 104 if the actual and predicted classifications are the same. In response to the actual classification failing to match the predicted classification, the process 400 proceeds to a block 440. In response to the actual classification matching the predicted classification, the process 400 proceeds to a decision block 445.

In the block 440, the computer 100 sets a flag indicating that the computer 100 shall send a notification to the server 106 that the actual classification of the current road segment 104 failed to match the predicted classification of the current road segment 104. The notification can include the actual classification of the current road segment 104. After the block 440, the process 400 proceeds to the decision block 445.

In the decision block 445, the computer 100 determines whether the actual operation of the vehicle 102 while traveling over the current road segment 104 from the block 430 matches the predicted operation of the vehicle 102 while traveling over the current road segment 104 from the block 420. For example, the computer 100 can determine whether a similarity measure between the actual and predicted operations of the vehicle 102 is above a similarity threshold. Examples of similarity measures include Kullback-Leibler divergence, cosine similarity, Euclidean distance, Mahalanobis distance, etc. The similarity threshold can be chosen, e.g., by experimentally determining a value at which variations among the same intended operation of the vehicle 102 are treated as similar and different intended operation of the vehicle 102 is treated as dissimilar, based on operation data from vehicles 102 traveling through a variety of classifications of road segments 104 with known intended operations of the vehicles 102. In response to the actual operation of the vehicle 102 failing to match the predicted operation of the vehicle 102, the process 400 proceeds to a block 450. In response to the actual operation of the vehicle 102 matching the predicted operation of the vehicle 102, the process 400 proceeds to a block 455.

In the block 450, the computer 100 sets a flag indicating that the computer 100 shall send a notification to the server 106 that the actual operation of the vehicle 102 while traveling over the current road segment 104 failed to match the predicted operation of the vehicle 102. The notification can include the actual operation. After the block 450, the process 400 proceeds to the block 455.

In the block 455, the computer 100 transmits the notifications for which flags were set in the blocks 440 and 450, if any, to the server 106 via the transceiver 114.

Next, in a decision block 460, the computer 100 determines whether the vehicle 102 has received an instruction responsive to the notification(s) to transmit the vehicle data. The computer 100 can wait for a preset duration to receive the instruction. The preset duration can be chosen based on a longest typical length of time for transmission to the server 106, a decision by the server 106, and transmission back from the server 106. Upon receiving the instruction, the process 400 proceeds to a block 465. Upon failing to receive the instruction, e.g., within the preset duration, the process 400 proceeds to a block 470.

In the block 465, the computer 100 transmits the vehicle data related to the current road segment 104 to the server 106 via the transceiver 114. The vehicle data is time-series data, as discussed above. The time-series data included in the transmission can begin, e.g., when the vehicle 102 enters the current road segment 104 and can end, e.g., when the vehicle 102 exits the current road segment 104. After the block 465, the process 400 proceeds to a decision block 475.

In the block 470, the computer 100 refrains from transmitting the vehicle data. In other words, the vehicle data related to the current road segment 104 is not sent to the server 106. After the block 470, the process 400 proceeds to a decision block 475.

In the decision block 475, the computer 100 determines whether the vehicle 102 is still running. If the vehicle 102 is still running, the process 400 returns to the block 410 to determine the predicted classifications for the next road segment 104 after the current road segment 104. If the vehicle 102 has been turned off, the process 400 ends.

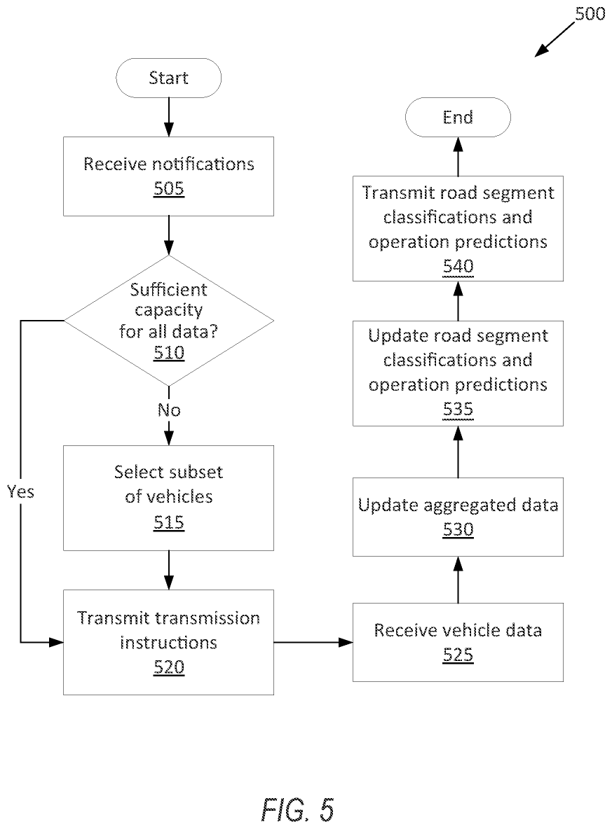

FIG. 5 is a process flow diagram illustrating an exemplary process 500 for instructing vehicles 102 to transmit the vehicle data to the server 106. The memory of the server 106 stores executable instructions for performing the steps of the process 500. As a general overview of the process 500, the server 106 receives the notifications from the plurality of vehicles 102. If the server 106 has sufficient capacity for the vehicle data from the vehicles 102 that sent notifications, then the server 106 transmits instructions to those vehicles 102 to transmit the vehicle data. If not, then the server 106 selects a subset of the vehicles 102 that sent notifications and transmits instructions to the vehicles 102 in the subset to transmit the vehicle data. The computer 100 receives the vehicle data, updates the aggregated data stored in the server 106 with the vehicle data, updates the classifications of the road segments 104, and transmits the map data including the updated classifications of the road segments 104.

The process 500 begins in a block 505, in which the server 106 receives a plurality of notifications from the vehicles 102, sent as described above with respect to the block 455. The total number of vehicles 102 that may be equipped to send the notifications to the server 106 is large, e.g., many thousands, so the server 106 will often receive many notifications within a short time interval. The server 106 can treat notifications received over a specific time interval together, e.g., 1 minute.

Next, in a decision block 510, the server 106 determines whether the vehicle data related to the notifications exceeds a capacity of the server 106. For example, the capacity of the server 106 can be a quantity of memory available in the server 106 to store the vehicle data, e.g., measured in terabytes. For example, the server 106 can estimate a total size of the vehicle data, e.g., by multiplying the number of vehicles 102 that sent notifications by a typical size of the vehicle data for one road segment 104 from one vehicle 102. The server 106 can then compare the estimated total size of the vehicle data with the quantity of memory available. Alternatively or additionally, the capacity can be a bandwidth of the server 106. Upon determining that the vehicle data exceeds the capacity, the process 500 proceeds to a block 515. Upon determining that the vehicle data is within the capacity, the process 500 proceeds to a block 520.

In the block 515, the server 106 selects a subset of the vehicles 102 from which to receive the vehicle data. The number of vehicles 102 in the subset is chosen so that the estimated total size of the vehicle data from the selected vehicles 102 is within the capacity of the server 106. For example, the server 106 can select the subset by selecting a random sample from among the vehicles 102 that sent notifications. More specifically, the server 106 can include at least one vehicle 102 for each unique road segment 104 for which a notification was sent, and the server 106 can select a random sample of the vehicles 102 that sent notifications of the same road segment 104. For example, if one vehicle 102 sent a notification about a first road segment 104, one vehicle 102 sent a notification about a second road segment 104, ten vehicles 102 sent notifications about a third road segment 104, and the server 106 has capacity for four vehicles 102, then the server 106 can select the vehicle 102 that sent the notification about the first road segment 104, the vehicle 102 that sent the notification about the second road segment 104, and two vehicles 102 at random from the ten vehicles 102 that sent notifications about the third road segment 104. If many vehicles 102 are transmitting notifications about the same road segment 104, then those notifications likely contain essentially the same new information, and a sampling is sufficient and keeps the amount of data transmission lower. After the block 515, the process 500 proceeds to the block 520.

In the block 520, the server 106 transmits instructions to transmit the vehicle data to the selected vehicles 102, either the subset of the vehicles 102 from the block 515 or all the vehicles 102 that sent notifications if the block 515 was skipped.

Next, in a block 525, the server 106 receives the vehicle data from the vehicles 102 to which the instructions were sent.

Next, in a block 530, the server 106 transforms the vehicle data into aggregated data and then deletes the vehicle data. The server 106 is already storing aggregated data, and the vehicle data is incorporated into the aggregated data. For example, the vehicle data is compared to the aggregated data and the confidence intervals of the aggregated data are adjusted based on the vehicle data becoming part of the sample underlying the confidence intervals. After incorporating the vehicle data into the aggregated data, the server 106 deletes the vehicle data unless subject to a request to save. A request to save is a user input to the server 106 specifying criteria, e.g., identity of a specific road segment 104, a type of vehicle 102, etc., for preventing deletion of the vehicle data. If there is a request to save, the server 106 deletes the vehicle data that do not satisfy the criteria and saves the vehicle data that do satisfy the criteria. Deleting the data frees up the capacity of the server 106 to receive more vehicle data.

Next, in a block 535, the server 106 updates the predicted classifications of the road segments 104 in the map data and updates the model for predicting the operation of the vehicles 102. For example, the predicted classifications of the road segments 104 can be based on the vehicle data about the respective road segments 104. For example, the sensor data of the vehicle data can be used to determine the actual classification of one of the road segments 104 by the computer 100 of the vehicle 102, as described above with respect to the block 425, and the actual classification can be included in the notification sent from that vehicle 102. The server 106 can change the predicted classification of that road segment 104 based on receiving that notification, or based on receiving multiple notifications with the same actual classification different than the predicted classification. Additionally, the server 106 can set the predicted classifications to unclassified for any road segment 104 for which a time threshold has elapsed since receiving any vehicle data about that road segment 104. In other words, if no notifications are received for a given road segment 104 over the time threshold, the predicted classification of the road segment 104 is set to unclassified. Doing this can capture situations in which the features of the road segment 104 have changed slightly but not enough to trigger a notification. The server 106 also updates the model for predicting the operation of the vehicles 102. For example, if the model is a statistical model as described above with respect to the block 415, then the statistical means or medians are adjusted based on the operation data within the vehicle data becoming part of the sample for the statistical model. For another example, if the model is an unsupervised machine learning program, then the operation data is used to update the centroids of the clusters and whether different classifications are represented in the clusters.

Next, in a block 540, the server 106 can transmit the map data and the model for predicting the operation of the vehicles 102 to the vehicles 102, specifically to all the vehicles 102 equipped to communicate with the server 106. The map data includes the predicted classifications of the road segments 104 that were updated in the block 535. After the block 540, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer comprising a processor and a memory storing instructions executable by the processor to:
determine a predicted classification related to a road segment;
upon a vehicle including the computer traveling over the road segment, determine an actual classification related to the road segment;
in response to the actual classification failing to match the predicted classification, transmit a notification to a server remote from the vehicle; and
upon receiving an instruction responsive to the notification, transmit vehicle data related to the road segment to the server.

2. The computer of claim 1, wherein the instructions further include instructions to, upon failing to receive the instruction responsive to the notification, refrain from transmitting the vehicle data.

3. The computer of claim 1, wherein the predicted classification related to the road segment is a predicted classification of the road segment, and the actual classification related to the road segment is an actual classification of the road segment.

4. The computer of claim 3, wherein the predicted classification of the road segment is a predicted physical layout of the road segment, and the actual classification of the road segment is an actual physical layout of the road segment.

5. The computer of claim 4, wherein the memory is storing map data including the predicted physical layout of the road segment.

6. The computer of claim 1, wherein the predicted classification related to the road segment is a predicted operation of the vehicle while traveling over the road segment, and the actual classification related to the road segment is an actual operation of the vehicle while traveling over the road segment.

7. The computer of claim 6, wherein the predicted operation of the vehicle includes predicted operation data for at least one of propulsion, steering, and braking, and the actual operation of the vehicle includes operation data for at least one of propulsion, steering, and braking.

8. The computer of claim 6, wherein the predicted operation of the vehicle includes a predicted vehicle path along the road segment, and the actual operation of the vehicle includes an actual vehicle path along the road segment.

9. The computer of claim 6, wherein determining the predicted operation of the vehicle while traveling over the road segment is based on a predicted classification of the road segment.

10. The computer of claim 1, wherein the vehicle data is time-series data.

11. The computer of claim 1, wherein the vehicle data includes operation data for at least one of propulsion, steering, and braking.

12. A server comprising a processor and a memory storing instructions executable by the processor to:
receive a plurality of notifications from a plurality of vehicles, the notifications indicating that respective actual classifications related to respective road segments traveled over by the respective vehicles fail to match respective predicted classifications related to the respective road segments;
determine whether vehicle data related to the notifications exceeds a capacity of the server;
upon determining that the vehicle data is within the capacity, transmit instructions to transmit the vehicle data to the vehicles;
upon determining that the vehicle data exceeds the capacity, select a subset of the vehicles; and
then transmit instructions to transmit the vehicle data to the vehicles in the subset.

13. The server of claim 12, wherein selecting the subset of the vehicles includes selecting a random sample from among the vehicles.

14. The server of claim 13, wherein the random sample is from the vehicles for which the notifications are of the same road segment.

15. The server of claim 12, wherein the instructions include instructions to transmit map data to the vehicles, and the map data include predicted classifications of the road segments.

16. The server of claim 15, wherein at least one of the predicted classifications of the road segments is based on the vehicle data about the respective road segments.

17. The server of claim 15, wherein the instructions include instructions to set the predicted classifications to unclassified for the road segments for which at least a time threshold has elapsed since receiving the vehicle data.

18. The server of claim 12, wherein the capacity of the server is a quantity of the memory available to store the vehicle data.

19. The server of claim 12, wherein the instructions include instructions to transform the vehicle data into aggregated data, and then delete the vehicle data.

20. A method comprising:
determining a predicted classification related to a road segment;
upon a vehicle traveling over the road segment, determining an actual classification related to the road segment;
in response to the actual classification failing to match the predicted classification, transmitting a notification to a server remote from the vehicle; and
upon receiving an instruction responsive to the notification, transmitting vehicle data related to the road segment to the server.
